(19) United States
(12) Patent Application Publication
(10) Pub. No.: US 2012/0225980 A1
(43) Pub. Date: Sep. 6, 2012

(54) METHODS OF FLAME RETARDING POLYETHYLENE PROCESSED AT HIGH TEMPERATURES

(75) Inventor: Mark Richard Parsons, Lake Saint Louis, MO (US)

(73) Assignee: BASF SE, Ludwigshafen (DE)

(21) Appl. No.: 13/347,055

(22) Filed: Jan. 10, 2012

Related U.S. Application Data
(60) Provisional application No. 61/437,819, filed on Jan. 31, 2011.

(51) Int. Cl. C08K 5/357; B29C 41/04; C08K 5/3492

(52) U.S. Cl. 524/97; 524/100; 524/101; 264/310

(57) ABSTRACT

Disclosed is a process for the preparation of a stabilized and flame retardant polyethylene article, which process comprises adding an effective stabilizing amount of one or more macrocyclic hindered amine light stabilizers and an effective flame retarding amount of one or more brominated flame retardants to a polyethylene substrate and subjecting the resultant polyethylene mixture to a high temperature of 250° C. or above, for instance to a temperature of 280° C. or above. The polyethylene articles are for example prepared by a high temperature rotomolding process or a high temperature film or laminate film extrusion process. The articles are white in color, have a smooth surface and produce little or no odor. The macrocyclic hindered amine is for example

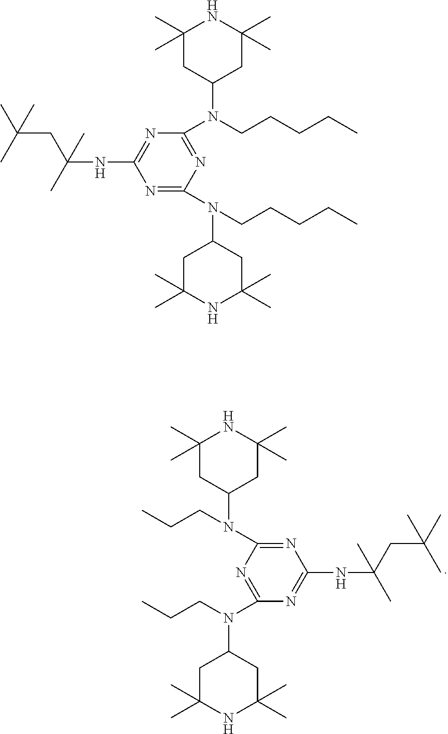

This application claims benefit of U.S. provisional app. No. 61/437,819, filed Jan. 31, 2011, the contents of which are hereby incorporated by reference.

The present disclosure relates to methods of flame retarding polyethylene, which polyethylene is processed at high temperature. The final polyethylene products are for instance polyethylene hollow articles prepared by a rotomolding process or are polyethylene films or multilayer films.

Polyethylene is in some instances processed at temperatures of 250° C. or higher, for instance 280° C. or higher. Most commonly, these processes include a rotomolding process or a laminate film process. Polyethylene is in many instances stabilized with hindered amine light stabilizers (HALS) and may be made flame retardant with the addition of for example brominated flame retardants.

It is known that hindered amine light stabilizers may interact with brominated flame retardants during high temperature melt processing, which results in a foamy, brown colored extrudate and a noticeable odor. This interaction may also render the hindered amine ineffective which results in poor outdoor weathering of the finished products.

The use of hindered amine light stabilizers together with brominated flame retardants in polyolefins is described for instance in U.S. Pat. Nos. 6,472,456, 5,393,812, 7,230,042 and 7,786,199. The hindered amines are generally N-hydrocarbyloxy hindered amines, also known as NOR hindered amines. NOR hindered amines are purported as not having a deleterious interaction with brominated flame retardants.

Conventional hindered amines, that is N—H or N-alkyl hindered amines, have not been suggested for use together with brominated flame retardants in polyolefins. This would be especially so for processes where the polyolefin is subjected to temperatures of 250° C. or above or 280° C. or above.

Conventional macrocyclic hindered amine light stabilizers are disclosed in U.S. Pat. No. 4,442,250. They are described as being useful for the stabilization of polyolefin articles.

It has surprisingly been found that certain conventional macrocyclic hindered amines, employed together with brominated flame retardants, provide polyethylene processed at high temperatures with no discoloration and little or no odor.

Disclosed is a process for the preparation of a stabilized and flame retardant polyethylene article, which process comprises

adding an effective stabilizing amount of one or more macrocyclic hindered amine light stabilizers and an effective flame retarding amount of one or more brominated flame retardants to a polyethylene substrate and

subjecting the resultant polyethylene mixture to a temperature of 250° C. or above,

where the hindered amine light stabilizers are of formula I

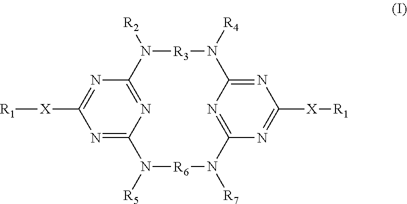

where

R₁ is hydrogen, C₁-C₁₈alkyl, C₃-C₁₈alkenyl, C₅-C₁₈cycloalkyl, C₆-C₁₈aryl, C₇-C₉aralkyl or —R₈—Y,

or R₁ is a group of formula II or III,

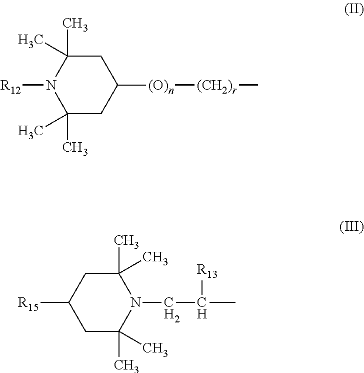

n is 0 or 1,

r is 0, 1, 2 or 3,

X is —O—, —S—, or —NR₁₆—,

XR₁ as a whole may also be chlorine or morpholino, pyrrolidin-1-yl, piperidin-1-yl or hexahydroazepin-1-yl,

R₂, R₄, R₅ and R₇ independently are hydrogen, C₁-C₁₂alkyl, C₂-C₆hydroxyalkyl, C₃-C₁₂alkenyl, C₅-C₁₂cycloalkyl, C₈-C₁₈aryl, C₇-C₉aralkyl or a group of formula II,

R₃ and R₆ independently are C₂-C₁₂alkylene, C₄-C₁₂iminodialkylene or oxadialkylene, C₅-C₁₂cycloalkylene, C₆-C₁₂arylene or C₇-C₁₂aralkylene,

R₈ is C₂-C₆alkylene,

Y is —O—R₉ or —NR₁₀R₁₁,

R₉ is hydrogen or C₁-C₁₈alkyl,

R₁₀ and R₁₁ are independently C₁-C₆alkyl, 2,2,6,6-tetramethylpiperid-4-yl or 1,2,2,6,6-pentamethylpiperid-4-yl,

R₁₂ is hydrogen, C₁-C₁₂alkyl, C₃-C₁₂alkenyl or C₇-C₉aralkyl,

R₁₃ is hydrogen, methyl, ethyl or phenyl,

R₁₄ is hydrogen, C₁-C₁₂alkyl, C₃-C₁₂alkenyl, C₇-C₉aralkyl or C₁-C₁₂acyl,

R₁₅ is hydrogen, C₁-C₈alkoxy, C₃-C₈alkenyloxy or benzyloxy and

R₁₆ is defined as for R₁ and

where at least one of the groups R₁, R₂, R₄, R₅ and R₇ is a group of formula II.

### DETAILED DISCLOSURE

Suitable polyethylene substrates are, for example, high density polyethylene (HDPE), high molecular weight high density polyethylene (HMW HDPE), ultrahigh molecular weight high density polyethylene (UHMW HDPE), medium density polyethylene (MDPE), low density polyethylene (LDPE), linear low density polyethylene (LLDPE), branched low density polyethylene (BLDPE) or polyethylenes and ethylene copolymers prepared using Phillips catalysts and polyethylene blends. Ethylene copolymers can in this case contain differing proportions of comonomers. Examples which may be mentioned are: 1-olefins such as propene, 1-butene, 1-pentene, 1-hexene, 1-heptene, 1-octene or isobutylene, styrene, cycloolefins such as cyclopentene, cyclohexene or norbornene or dienes such as butadiene, isoprene, 1,4-hexadiene, cyclopentadiene, dicyclopentadiene, norbornadiene or ethylidenenorbornene.

Polyethylene substrates also include polyethylene blends with polyolefins. Examples are mixtures of polyethylene with polypropylene (PP) and mixtures of various PE types, for example mixtures including high density polyethylene (HDPE), high molecular weight high density polyethylene (HMW HDPE), ultrahigh molecular weight high density polyethylene (UHMW HDPE), medium density polyethylene (MDPE), low density polyethylene (LDPE), linear low density polyethylene (LLDPE), branched low density polyethylene (BLDPE) and, in particular, ethylene-propylene-diene terpolymers (EPDM) containing high proportions of diene.

Polyethylene is under most conditions not processed at temperatures of 250° C. or above. In the present processes, the polyethylene mixtures are subjected to high temperatures of 250° C. or above, for instance 260° C. or above, 270° C. or above, 280° C. or above, 290° C. or above or 300° C. or above.

Preferably, the polyethylene mixtures are subjected to temperatures of 280° C. or above. The present high temperatures are required for the preparation of the final polyethylene article.

The present processes include for instance a rotational molding (rotomolding) process or a film or laminate film extrusion process, which processes employ the high temperatures of 250° C. or higher mentioned above. The polyethylene article is generally a film, a laminated film or article or a rotomolded article.

Prior to final formation into a molded article or film or laminate film, the polyethylene substrate and additives, including the hindered amine and brominated flame retardant, may be melt blended in for example an extruder, kneader or mixer. The molten polyethylene mixture is cooled and normally granulated. The granulated and “additized” polyethylene is subsequently subjected to the high temperature conditions of a final fabrication step of the present processes.

Polymer masterbatches containing high levels of additives may also be employed. Masterbatches may contain for instance up to about 40% by weight additives or higher, based on the weight of the polymer. Polyethylene may be employed as the polymer of the masterbatch, or alternatively, another thermoplastic polymer may be used.

Alternatively, the polyethylene substrate and the light stabilizer and flame retardant additives (additized polyethylene or polyethylene mixture) may be melt blended together in the final stage of an article fabrication step, such as in an extruder used to melt and convey the polyethylene composition for a molding step such as a film molding step.

Rotomolding (rotational molding) is used for the production of fairly large plastic hollow articles which may be reinforced with glass fibers. The process includes filling one half of a mold with the plastic material. The mold is then closed with the other half and heated and rotated in an oven such that the molten plastic spreads to the walls of the mold while being rotated around different axes. The hollow article is obtained after cooling. In this manner it is possible to produce, for example, storage tanks from HD polyethylene. The process normally requires temperatures in the range above 300° C., sometimes even above 400° C.

Films may be monolayer or multilayer films. These films may be formed by any of the conventional techniques known in the art including extrusion, co-extrusion, extrusion coating, lamination, blowing and casting. The film may be obtained by the flat film or tubular process which may be followed by orientation in an uniaxial direction or in two mutually perpendicular directions in the plane of the film. One or more of the layers of the film may be oriented in the transverse and/or longitudinal directions to the same or different extents. This orientation may occur before or after the individual layers are brought together. For example a polyethylene layer can be extrusion coated or laminated onto an oriented polypropylene layer or the polyethylene and polypropylene can be coextruded together into a film then oriented. Likewise, oriented polypropylene could be laminated to oriented polyethylene or oriented polyethylene could be coated onto polypropylene then optionally the combination could be oriented even further. Typically the films are oriented in the Machine Direction (MD) at a ratio of up to 15, preferably between 5 and 7, and in the Transverse Direction (TD) at a ratio of up to 15 preferably 7 to 9. However in another embodiment the film is oriented to the same extent in both the MD and TD directions.

The polyethylene composition may be used as a layer of a multilayer or multi-ply article or laminate material. A laminate has at least two layers of material. The laminate may be a film construction in which one layer has the polyethylene composition with a brominated compound and a hindered amine light stabilizer. The laminate may have more than one such layer. The laminate may further include a layer including one or more polymers, for example a polymer selected from polyesters, polyurethanes, polyamides (nylons), other polyolefin compositions, vinyl polymers such as polysytrenes, polyvinyl acetates, and acrylic polymers, epoxy polymers, polyacrylonitriles, polyureas, polyimides, polycarbonates, copolymers, grafts, and blends of combinations of the foregoing polymers, as well as thermoplastic elastomers and thermoset elastomers. The film layers may be laminated on paper, wood, cardboard, metal, metal foils, metalized surfaces, glass, fabric, spunbonded fibers, non-woven fabrics (particularly polypropylene non-wovens) or on substrates coated with inks, dyes, pigments and the like.

The polyethylene films may vary in thickness depending on the intended application, for instance a thickness of 1 to 5,000 μm, preferably from 1 to 3,500 μm. However films of a thickness of from 1 to 100 μm or from 1 to 250 μm are usually suitable. Films intended for packaging are usually from 10 to 60 micron thick. The thickness of a sealing layer is typically 0.2 to 50 μm. There may be a sealing layer on both the inner and outer surfaces of the film or the sealing layer may be present on only the inner or the outer surface.

One example of a laminate is a woven or nonwoven web laminate having a fabric layer that is a woven or nonwoven web of fiber (e.g., polyester, polyethylene, cotton, or nylon (polyamide) fiber) coated with a layer of the polyethylene composition. The laminated fabric may be made through the application of heat and pressure, for example using a mold, press, or by forming a wound bundle of the fabric and polyethylene film. The layers may be heated under pressure for a sufficient length of time to produce the laminate.

The additized polyethylene may also be used to prepare molded products in any molding process, including but not limited to, injection molding, gas-assisted injection molding, extrusion blow molding, injection blow molding, injection stretch blow molding, compression molding, rotational molding, foam molding, thermoforming, sheet extrusion, and profile extrusion. The molding processes are well known to those of ordinary skill in the art. The compositions described herein may be shaped into desirable end use articles by any suitable means known in the art. Thermoforming, vacuum forming, blow molding, rotational molding, slush molding, transfer molding, wet lay-up or contact molding, cast molding, cold forming matched-die molding, injection molding, spray techniques, profile co-extrusion, or combinations thereof are typically used methods.

As mentioned, the final polyethylene articles are generally films, laminated films or articles or rotomolded hollow articles. The final articles may also be tapes, sheets, fibers or other solid molded products.

In other processes, the additized polyethylene may be formed into an article by thermoforming blow molding, profile co-extrusion or injection molding processes.

The present processes include at least one step in which the additized polyethylene is subjected to the present high temperatures of 250° C. or above.

The present hindered amine light stabilizers and brominated flame retardants may be combined together in a densified form, such as a pellet or compacted granulate. The densified combination then may be employed for addition to the polyethylene substrate. Alternatively, the additives may be added separately in one melt stage or in different melt stages.

Accordingly, another aspect of the present invention is an additive composition comprising one or more macrocyclic hindered amine light stabilizers of formula I and one or more brominated flame retardants.

In the densified additive composition comprising the hindered amines of formula I and the brominated flame retardants, the weight:weight ratio of hindered amines to brominated flame retardants ranges from 1:99 to 99:1.

The preparation of the present macrocyclic hindered amine light stabilizers of formula I are disclosed in U.S. Pat. No. 4,442,250, the contents of which are incorporated by reference.

The compounds of formula I are for example the cyclic condensates of N,N′-bis(2,2,6,6-tetramethyl-4-piperidyl)-hexamethylenediamine and 4-tert-octylamino-2,6-dichloro-1,3,5-triazine, of N,N′-bis(2,2,6,6-tetramethyl-4-piperidyl) hexamethylenediamine and 4-cyclohexylamino-2,6-dichloro-1,3,5-triazine, or of N,N′-bis-(2,2,6,6-tetramethyl-4-piperidyl)hexamethylenediamine and 4-morpholino-2,6-dichloro-1,3,5-triazine:

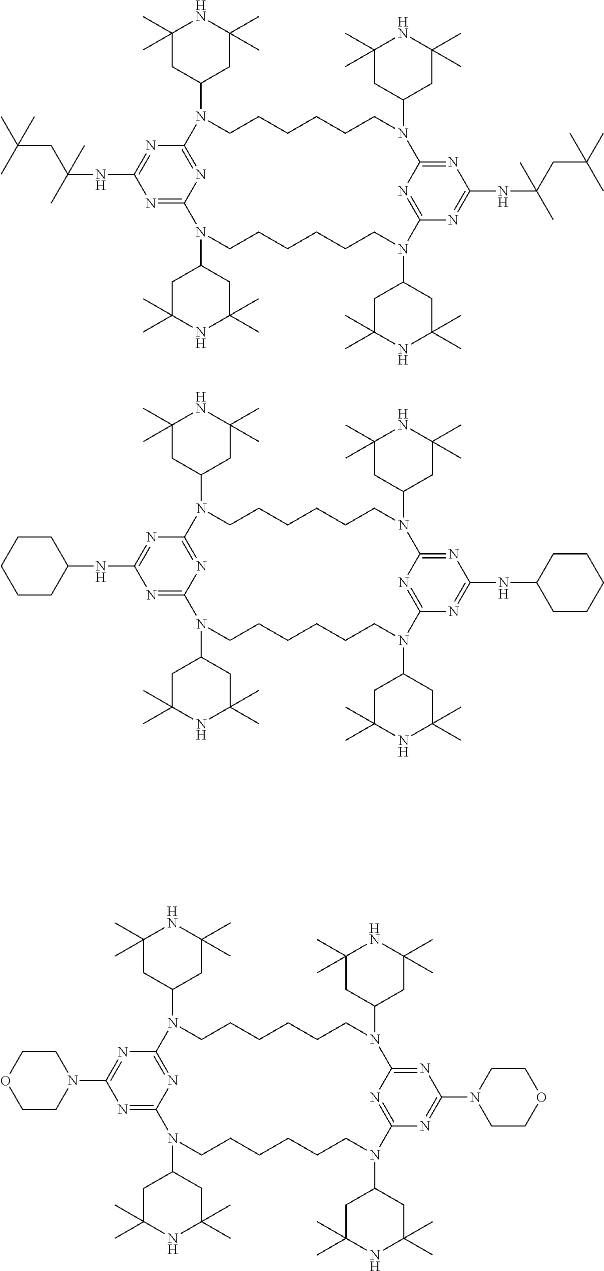

R₁₂ is preferably hydrogen or methyl.

R₃ and R₆ are preferably C₂-C₁₂alkylene.

X is preferably —O— or —NR₁₆—.

R₁₆ is preferably hydrogen and R₁ is preferably C₁-C₁₈alkyl.

R₁X is preferably t-octylamino or morpholino.

The compounds of formula I may also be in the form of organic or inorganic acid salts. For example salts of the formula (I).(HY)ₙ where HY is an organic or inorganic acid and n is an integer of 1 to 4.

For example HY is selected from the group consisting of a halogen containing inorganic protonic acid, a phosphorus containing inorganic acid, a sulfur containing inorganic acid, a C₁-C₄alkyl carboxylic acid, a perfluoro C₁-C₄alkyl carboxylic acid and an aromatic carboxylic acid.

Alkyl is a branched or unbranched group and is for example methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetra-methylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl or 1,1,3,3,5,5-hexamethylhexyl.

Alkenyl is an unsaturated version of alkyl, for example isopropenyl, propenyl, hexenyl, heptenyl, and the like.

Cycloalkyl is substituted or unsubstituted and is, for example, cyclopentyl, methylcyclopentyl, dimethylcyclopentyl, cyclohexyl, methylcyclohexyl, dimethylcyclohexyl, trimethylcyclohexyl, tert-butylcyclohexyl, cycloheptyl or cyclooctyl. For example cyclohexyl or tert-butylcyclohexyl.

Aryl is for example phenyl or naphthyl or biphenyl, but also comprised are C₁-C₄alkyl substituted phenyl, C₁-C₄alkoxy substituted phenyl, hydroxy, halogen or nitro substituted phenyl. Examples for alkyl substituted phenyl are ethylbenzene, toluene, xylene and its isomers, mesitylene or isopropylbenzene. Halogen substituted phenyl is for example dichlorobenzene or bromotoluene.

Aralkyl is for example phenylalkyl which is unsubstituted or substituted on the phenyl group by from 1 to 3 C₁-C₄alkyl groups and is, for example, benzyl, α-methylbenzyl, α,α-dimethylbenzyl, 2-phenylethyl, 2-methylbenzyl, 3-methylbenzyl, 4-methylbenzyl, 2,4-dimethylbenzyl, 2,6-dimethylbenzyl or 4-tert-butylbenzyl. For example benzyl.

Alkylene is a branched or unbranched divalent group, for example methylene, ethylene, propylene, trimethylene, tetramethylene, pentamethylene, hexamethylene, heptamethylene, octamethylene, decamethylene or dodecamethylene.

Cycloalkylene is a saturated hydrocarbon group having two free valences and at least one ring unit and is, for example, cyclopentylene, cyclohexylene, cycloheptylene or cyclooctylene. For example cyclohexylene.

Arylene is phenylene or naphthylene or biphenylene, each unsubstituted or substituted by C₁-C₄alkyl, for example, 1,2-, 1,3- or 1,4-phenylene or 1,2-, 1,3-, 1,4-, 1,6-, 1,7-, 2,6- or 2,7-naphthylene. For instance 1,4-phenylene.

Aralkylene is for instance phenylalkylidene and is, for example, benzylidene, 2-phenylethylidene or 1-phenyl-2-hexylidene.

The hindered amine light stabilizers are added in an amount effective for the desired use of the final article, such as in an amount of about 0.01% to about 10% by weight, based on the weight of the polyethylene substrate. In various embodiments, the hindered amine light stabilizer may be added in an amount of at least 0.2% or at least 0.5% and/or up to about 3% or up to about 2% by weight, based on the weight of the polyethylene substrate. Preferably, the hindered amine light stabilizers are added in an amount of about 0.5% to about 7% or from about 0.5% to about 5% by weight, based on the weight of the polyethylene substrate. The hindered amine light stabilizer may be accordingly more concentrated in an additive or masterbatch composition by which it may be introduced into a polyethylene composition that is formed into the final article. Thus, these weight percents represent the amounts based on the polyethylene substrate in the final polyethylene article.

The brominated flame retardants are commercially available and are listed for instance in U.S. Pat. Nos. 6,472,456, 5,393,812, 7,230,042 and 7,786,199, the disclosures of which are incorporated by reference.

Brominated flame retardants include, without limitation, tetrabromobisphenol A (TBBPA) and its derivatives such as esters, ethers, and oligomers, for example tetrabromophthalate esters, bis(2,3-dibromopropyloxy)tetrabromobisphenol A, brominated carbonate oligomers based on TBBPA, brominated epoxy oligomers based on condensation of TBBPA and epichlorohydrin, and copolymers of TBBPA and 1,2-dibromoethane; dibromobenzoic acid, dibromostyrene (DBS) and its derivatives; ethylenebromobistetrabromophthalimide, dibromoneopentyl glycol, dibromocyclooctane, trisbromoneopentanol, tris(tribromophenyl)triazine, 2,3-dibromopropanol, tribromoaniline, tribromophenol, tetrabromocyclopentane, tetrabromobiphenyl ether, tetrabromodipentaerythritol, decabromodiphenyl ether, tetrabromophthalic anhydride, pentabromotoluene, pentabromodiphenyl ether, pentabromodiphenyl oxide, pentabromophenol, pentabromophenyl benzoate, pentabromoethylbenzene, hexabromocyclohexane, hexabromocyclooctane, hexabromocyclodecane, hexabromocyclododecane, hexabromobenzene, hexabromobiphenyl, octabromobiphenyl, octabromodiphenyl oxide, poly(pentabromobenzyl acrylate), octabromodiphenyl ether, decabromodiphenyl ethane, decabromodiphenyl oxide, decabromodiphenyl ether, decabromodiphenyl, brominated trimethylphenylindan, tetrabromochlorotoluene, bis(tetrabromophthalimido)ethane, bis(tribromophenoxy)ethane, brominated polystyrene, brominated epoxy oligomer, polypentabromobenzyl acrylate, dibromopropylacrylate, dibromohexachlorocyclopentadienocyclooctane, N′-ethyl(bis)dibromononboranedicarboximide, tetrabrombisphenol S, N′N′-ethylbis(dibromononbornene)dicarboximide, hexachlorocyclopentadieno-bis-(2,3-dibromo-1-propyl)phthalate, brominated phosphates like bis(2,3-dibromopropyl)phosphate and tris(tribromoneopentyl)phosphate and tris(dichlorobromopropyl)phosphite, N,N′-ethylene-bis-(tetrabromophthalimide), tetrabromophthalic acid diol[2-hydroxypropyl-oxy-2-2-hydroxyethyl-ethyltetrabromophthalate], vinylbromide, polypentabromobenzyl acrylate, polybrominated dibenzo-p-dioxins, tris-(2,3-dibromopropyl)-isocyanurate, ethylene-bis-tetrabromophthalimide and tris(2,3-dibromopropyl)phosphate.

Suitable examples of commercially available brominated flame retardants include polybrominated diphenyl oxide (DE-60F), decabromodiphenyl oxide (DBDPO; SAYTEX® 102E), tris[3-bromo-2,2-bis(bromomethyl)propyl]phosphate (PB 370®, FMC Corp. or FR 370, ICL/Ameribrom), tris(2,3-dibromopropyl)phosphate, tetrabromophthalic acid, bis-(N,N′-hydroxyethyl)tetrachlorphenylene diamine, tetrabromobisphenol A bis(2,3-dibromopropyl ether) (PE68), brominated epoxy resin, ethylene-bis(tetrabromophthalimide) (SAYTEX® BT-93), octabromodiphenyl ether, 1,2-bis(tribromophenoxy)ethane (FF680), tetrabromo-bisphenol A (SAYTEX® RB100), ethylene bis-(dibromo-norbornanedicarboximide) (SAYTEX® BN-451) and tris-(2,3-dibromopropyle)-isocyanurate.

It is also contemplated that chlorinated flame retardants may successfully be employed together or in place of the present brominated flame retardants. Chlorinated flame retardants are also disclosed in U.S. Pat. Nos. 6,472,456, 5,393,812, 7,230,042 and 7,786,199. Chlorinated flame retardants are for example tris(2-chloroethyl)phosphite, bis-(hexachlorocycloentadeno) cyclooctane, tris(1-chloro-2-propyl)phosphate, tris(2-chloroethyl)phosphate, bis(2-chloroethyl)vinyl phosphate, hexachlorocyclopentadiene, tris(chloropropyl)phosphate, tris(2-chloroethyl)phosphate, tris(chloropropyl)phosphate, polychlorinated biphenyls, mixtures of monomeric chloroethyl phosphonates and high boiling phosphonates, tris(2,3-dichloropropyl)phosphate, chlorendic acid, tetrachlorophthalic acid, poly-β-chloroethyl triphosphonate mixture, bis(hexachlorocyclopentadieno)cyclooctane (DECLORANE PLUS), chlorinated paraffins and hexachlorocyclopentadiene derivatives.

The brominated flame retardants are present in the final article in an effective amount, which may be determined by standard tests. The brominated flame retardants may be added in amounts of from about 0.01 to about 30% by weight or from about 0.2% to about 20% by weight or from about 0.5% to about 15% by weight or from about 1% to about 5% by weight, based on the weight of the polyethylene substrate. In various embodiments, the brominated flame retardant is added in an amount of at least 0.2% or at least 0.5% or at least 1% or at least 5% and/or up to about 3% or up to about 5% or up to about 10% or up to about 15% or up to about 20% by weight, based on the weight of the polyethylene substrate. The brominated compounds may be accordingly more concentrated in an additive or masterbatch composition by which it may be introduced into a polyethylene substrate that is formed into the final article. Thus, these weight levels represent the final weight percent based on the polyethylene substrate in the final polyethylene article.

Further additives may added to the polyethylene substrates of the invention. For instance, ultraviolet light absorbers selected from hydroxyphenylbenzotriazole, hydroxyphenyltriazine, benzophenone and benzoate UV absorbers, organic phosphorus stabilizers, hydroxylamine stabilizers, benzofuranone stabilizers, amine oxide stabilizers, hindered phenol antioxidants and/or further hindered amine light stabilizers. The further additives are for instance employed at levels of about 0.1 to about 10% by weight, based on the weight of the polyethylene substrate.

In particular, further additives are selected from the organic phosphorus stabilizers, hindered phenol antioxidants, hydroxylamines, other hindered amines and benzoate UV absorbers.

The organic phosphorus stabilizers are for example known phosphite and phosphonite stabilizers and include triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, bis(2,4-di-cumylphenyl)pentaerythrtitol diphosphite, diisodecyl pentaerythritol diphosphite, bis(2,4-di-tert-butylphenyl)pentaerythritol diphosphite (D), bis(2,6-di-tert-butyl-4-methylphenyl)pentaerythritol diphosphite (E), bisisodecyloxy-pentaerythritol diphosphite, bis(2,4-di-tert-butyl-6-methylphenyl)pentaerythritol diphosphite, bis(2,4,6-tri-tert-butylphenyl)pentaerythritol diphosphite, tristearyl sorbitol triphosphite, tetrakis-(2,4-di-tert-butylphenyl) 4,4′-biphenylene-diphosphonite (H), 6-isooctyloxy-2,4,8,10-tetra-tert-butyl-dibenzo[d,f][1,3,2]dioxaphosphepin (C), 6-fluoro-2,4,8,10-tetra-tert-butyl-12-methyl-dibenzo[d,g][1,3,2]dioxaphosphocin (A), bis(2,4-di-tert-butyl-6-methylphenyl)methyl phosphite, bis(2,4-di-tert-butyl-6-methylphenyl)ethyl phosphite (G), 2,2′,2″-nitrilo[triethyltris(3,3′5,5′-tetra-tert-butyl-1,1′-biphenyl-2,2′-diyl)phosphite] (B), bis(2,4-di-t-butylphenyl)octylphosphite, poly(4,4′-{2,2′-dimethyl-5,5′-di-t-butylphenylsulfide-}octylphosphite), poly(4,4′{-isopropylidenediphenol}-octylphosphite), poly(4,4′-{isopropylidenebis[2,6-dibromophenol]}-octylphosphite), poly(4,4′-{2,2′-dimethyl-5,5′-di-t-butylphenylsulfide}-pentaerythrityl diphosphite),

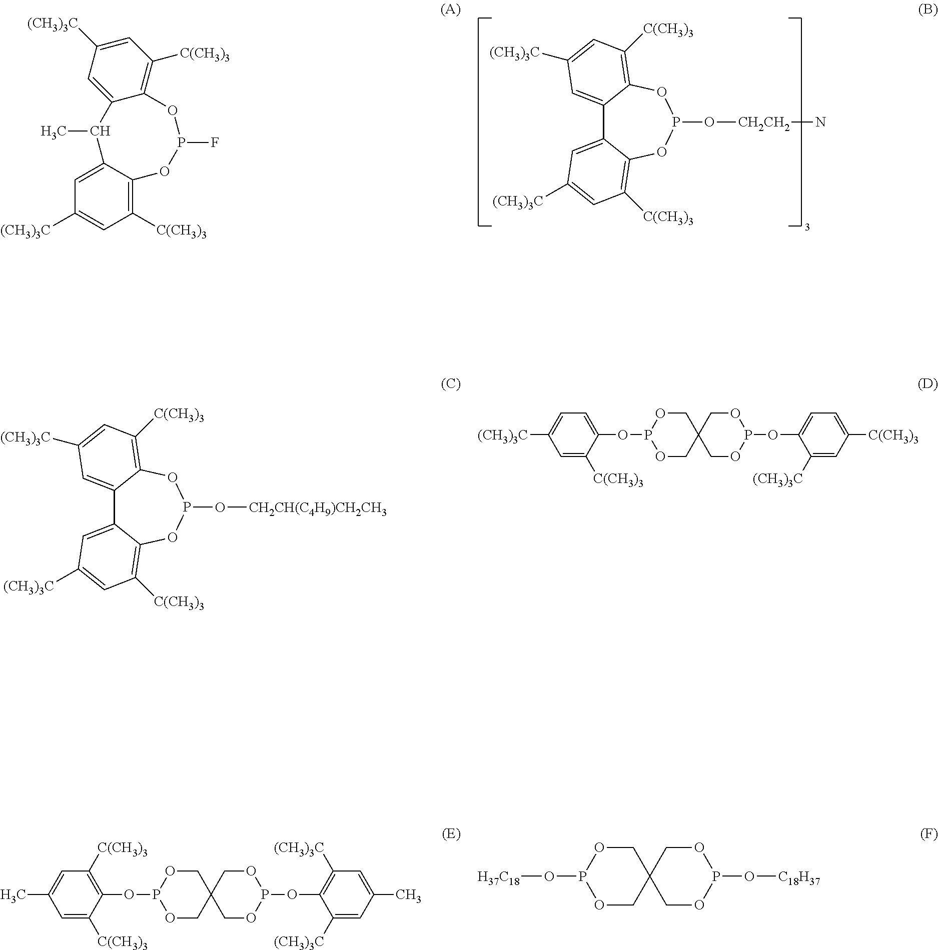

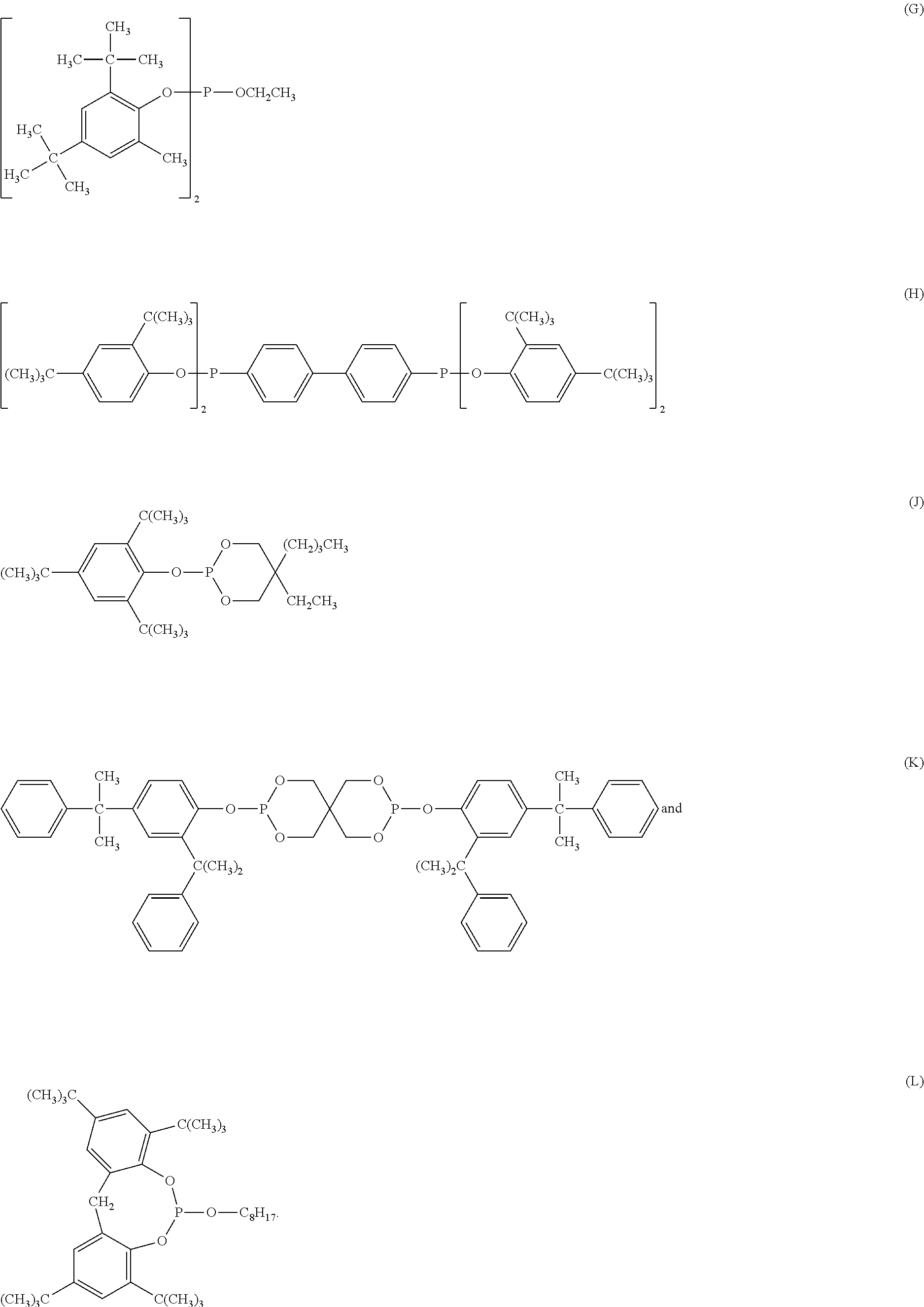

Hindered phenolic antioxidants include for example tris(3,5-di-tert-butyl-4-hydroxybenzyl)isocyanurate, 1,3,5-tris-(3,5-di-tert-butyl-4-hydroxybenzyl)-2,4,6-trimethylbenzene, the calcium salt of the monoethyl ester of 3,5-di-tert-butyl-4-hydroxybenzylphosphonic acid, pentaerythritol tetrakis [3-(3,5-di-tert-butyl-4-hydroxyphenyl)propionate] or octadecyl 3-(3,5-di-tert-butyl-4-hydroxyphenyl)propionate.

Hindered amine light stabilizers include for example
the condensate of 1-(2-hydroxyethyl)-2,2,6,6-tetramethyl-4-hydroxypiperidine and succinic acid, MW 3100-4000

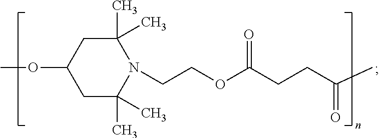

linear condensates of N,N′-bis(2,2,6,6-tetramethyl-4-piperidyl)-hexamethylenediamine and 4-tert-octylamino-2,6-dichloro-1,3,5-triazine, MW 1200-3100

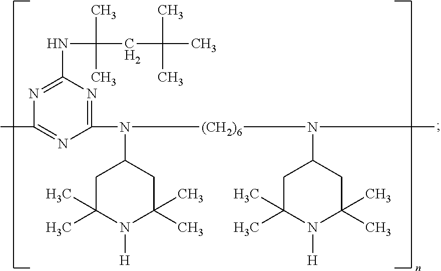

the condensate of 2-chloro-4,6-di-(4-n-butylamino-1,2,2,6,6-pentamethylpiperidyl)-1,3,5-triazine and 1,2-bis-(3-aminopropylamino)ethane,

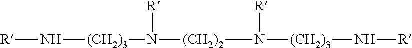

where R′ is

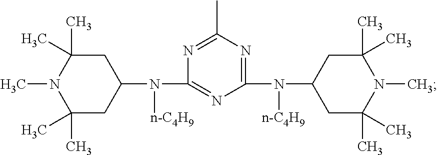

the oligomeric compound which is the condensation product of 4,4′-hexa-methylenebis(amino-2,2,6,6-tetramethylpiperidine) and 2,4-dichloro-6-[(2,2,6,6-tetramethylpiperidin-4-yl)butylamino]-s-triazine end-capped with 2-chloro-4,6-bis(dibutylamino)-s-triazine, MW 2600-3400

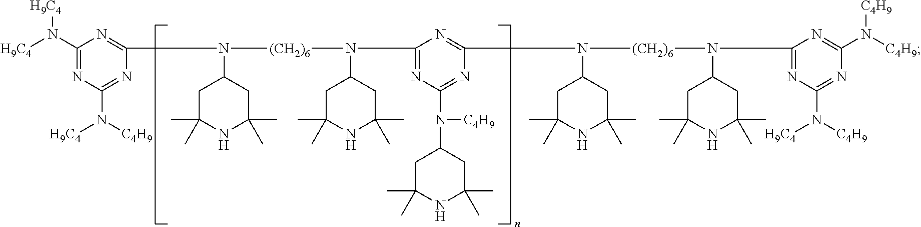

product obtained by reacting a product, obtained by reacting 1,2-bis(3-aminopropylamino)ethane with cyanuric chloride, with (2,2,6,6-tetramethyl-piperidin-4-yl)butylamine,

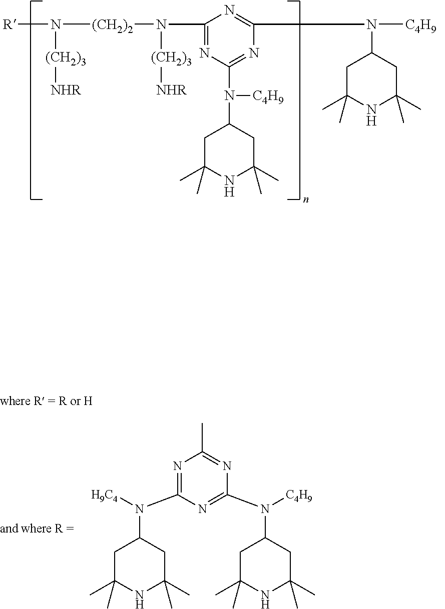

linear condensates of N,N′-bis-(2,2,6,6-tetramethyl-4-piperidyl)-hexamethylenediamine and 4-morpholino-2,6-dichloro-1,3,5-triazine,

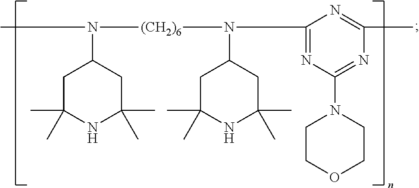

linear condensates of N,N′-bis-(1,2,2,6,6-pentamethyl-4-piperidyl)-hexamethylenediamine and 4-morpholino-2,6-dichloro-1,3,5-triazine,

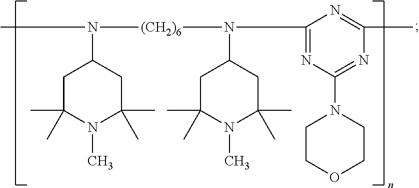

a reaction product of 7,7,9,9-tetramethyl-2-cycloundecyl-1-oxa-3,8-diaza-4-oxospiro[4,5]decane and epichlorohydrin,

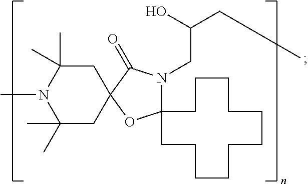

reaction product of maleic acid anhydride-C₁₈-C₂₂— -olefin-copolymer with 2,2,6,6-tetramethyl-4-aminopiperidine,

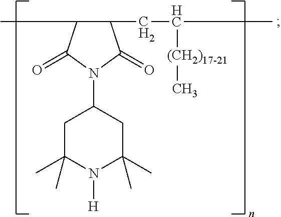

the reaction product of 2,4-bis[(1-cyclohexyloxy-2,2,6,6-piperidin-4-yl)-butylamino]-6-chloro-s-triazine with N,N′-bis(3-aminopropyl)ethylenediamine),

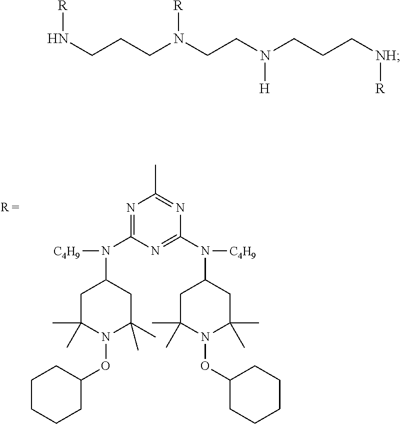

the oligomeric compound which is the condensation product of 4,4′-hexa-methylenebis(amino-1-propoxy-2,2,6,6-tetramethylpiperidine) and 2,4-dichloro-6-[(1-propoxy-2,2,6,6-tetramethylpiperidin-4-yl)butylamino]-s-triazine end-capped with 2-chloro-4,6-bis(dibutylamino)-s-triazine, MW 2600-3400

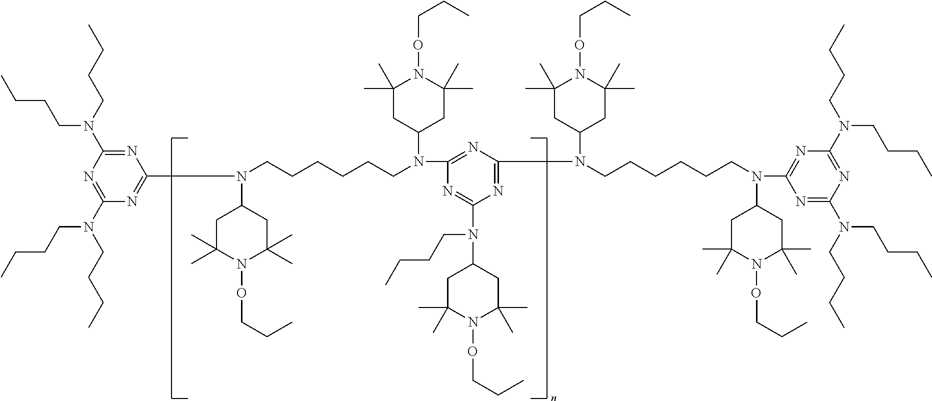

and
the oligomeric compound which is the condensation product of 4,4′-hexa-methylenebis(amino-1,2,2,6,6-pentaamethylpiperidine) and 2,4-dichloro-6-[(1,2,2,6,6-pentaamethylpiperidin-4-yl)butylamino]-s-triazine end-capped with 2-chloro-4,6-bis(dibutylamino)-s-triazine,

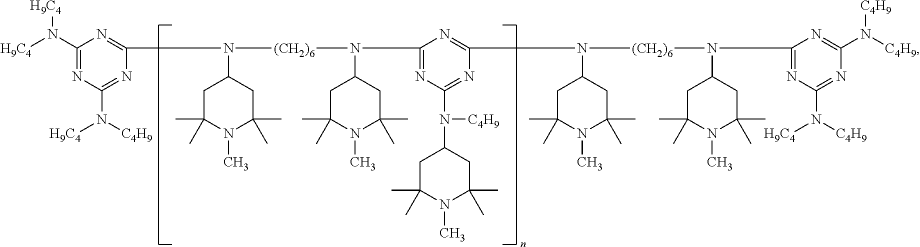

where n is an integer such that the total molecular weight is above about 1000 g/mole.

In particular, other useful hindered amines are those of the class of NOR hindered amines, N-hydrocarbyloxy hindered amines, disclosed in U.S. Pat. Nos. 6,472,456, 5,393,812, 7,230,042, 7,786,199 and 6,388,072, the contents of which are hereby incorporated by reference. The other hindered amines are in particular cyclohexyloxy hindered amines, in particular the reaction product of 2,4-bis[(1-cyclohexyloxy-2,2,6,6-piperidin-4-yl)butylamino]-6-chloro-s-triazine with N,N′-bis(3-aminopropyl)ethylenediamine).

Hydroxylamine stabilizers are for example N,N-dibenzylhydroxylamine, N,N-diethylhydroxylamine, N,N-dioctylhydroxylamine, N,N-dilaurylhydroxylamine, N,N-didodecylhydroxylamine, N,N-ditetradecylhydroxylamine, N,N-dihexadecylhydroxylamine, N,N-dioctadecylhydroxylamine, N-hexadecyl-N-tetradecylhydroxylamine, N-hexadecyl-N-heptadecylhydroxylamine, N-hexadecyl-N-octadecylhydroxylamine, N-heptadecyl-N-octadecylhydroxylamine, N-methyl-N-octadecylhydroxylamine or N,N-di(hydrogenated tallow)hydroxylamine.

The amine oxide stabilizer is for example GENOX EP, a di(C₁₆-C₁₈)alkyl methyl amine oxide, CAS#204933-93-7.

Benzofuranone stabilizers are for example 3-(4-(2-acetoxyethoxy)phenyl)-5,7-di-tert-butyl-benzofuran-2-one, 5,7-di-tert-butyl-3-(4-(2-stearoyloxyethoxy)phenyl)-benzofuran-2-one, 3,3′-bis(5,7-di-tert-butyl-3-(4-(2-hydroxyethoxy)phenyl)benzofuran-2-one), 5,7-di-tert-butyl-3-(4-ethoxyphenyl)benzofuran-2-one, 3-(4-acetoxy-3,5-dimethylphenyl)-5,7-di-tert-butyl-benzofuran-2-one, 3-(3,5-dimethyl-4-pivaloyloxyphenyl)-5,7-di-tert-butyl-benzofuran-2-one, 3-(3,4-dimethylphenyl)-5,7-di-tert-butyl-benzofuran-2-one or 3-(2,3-dimethylphenyl)-5,7-di-tert-butyl-benzofuran-2-one.

Benzoate UV absorbers are for instance esters of substituted and unsubstituted benzoic acids, as for example 4-tert-butylphenyl salicylate, phenyl salicylate, octylphenyl salicylate, dibenzoyl resorcinol, bis(4-tert-butylbenzoyl) resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

Hydroxyphenylbenzotriazole, hydroxyphenyltriazine and benzophenone UV absorbers are well known and are disclosed for instance in U.S. Pat. No. 6,444,733.

Colorants, pigments and fillers may also be added to the present polyethylene substrates

Suitable pigments are inorganic pigments, such as titanium dioxide in its three crystalline forms: rutile, anatase, or brookite, ultramarine blue, iron oxides, bismuth vanadates, carbon black, effect pigments including metallic pigments such as aluminum flake and pearlescent pigments such as micas, and organic pigments, for example phthalocyanines, perylenes, azo compounds, isoindolines, quinophthalones, diketopyrrolopyrroles, quinacridones, dioxazines, and indanthrones. Pigments may be included singly or in any combination in amounts typically of up to about 5% by weight, based on the weight of the polyethylene substrate.

Dyes are any of the colorants which dissolve completely in the plastic used or are present in molecularly dispersed form and therefore can be used to provide high-transparency, non-diffusion coloring of polymers. Other dyes are organic compounds which fluoresce in the visible portion of the electromagnetic spectrum, e.g. fluorescent dyes. Dyes may be included singly or in any combination in amounts typically of up to about 5% by weight, based on the weight of the polyethylene substrate.

Particulate fillers may be present in an amount from 0.001 to 50 wt % in one embodiment, and from 0.01 to 25 wt %, based upon the weight of the polyethylene substrate, in another embodiment, and from 0.2 to 10 wt % in yet another embodiment. Desirable fillers include but are not limited to titanium dioxide, silicon carbide, silica (and other oxides of silica, precipitated or not), antimony oxide, lead carbonate, zinc white, lithopone, zircon, corundum, spinel, apatite, barytes powder, barium sulfate, carbon black, dolomite, calcium carbonate, talc and hydrotalcite compounds of the ions Mg, Ca, or Zn with Al, Cr or Fe and CO₃ and/or HPO₄, hydrated or not; quartz powder, hydrochloric magnesium carbonate, glass fibers, clays, alumina, and other metal oxides and carbonates, metal hydroxides, chrome, phosphorous, antimony trioxide, silica, silicone, and blends thereof. These fillers may particularly include any other fillers and porous fillers and supports known in the art.

Other (non-brominated) flame retardants may also be employed in the processes of this invention.

Other flame retardants that are not halogenated may be included in the present polyethylene compositions. Phosphorus-containing flame retardants may be selected from phosphazene flame retardants, which are well known in the art and are disclosed for example in EP1104766, JP07292233, DE19828541, DE1988536, JP11263885, U.S. Pat. Nos. 4,079,035, 4,107,108, 4,108,805, and 6,265,599. Non-halogenated phosphorous-based fire retardants are compounds that include phosphorous, such as triphenyl phosphates, phosphate esters, phosphonium derivatives, phosphonates, phosphoric acid esters and phosphate esters, and those described in U.S. Pat. No. 7,786,199. Phosphorous-based fire retardants are usually composed of a phosphate core to which is bonded alkyl (generally straight chain) or aryl (aromatic ring) groups. Examples include red phosphorous, inorganic phosphates, insoluble ammonium phosphate, ammonium polyphosphate, ammonium urea polyphosphate, ammonium orthophosphate, ammonium carbonate phosphate, ammonium urea phosphate, diammonium phosphate, ammonium melamine phosphate, diethylenediamine polyphosphate, dicyandiamide polyphosphate, polyphosphate, urea phosphate, melamine pyrophosphate, melamine orthophosphate, melamine salt of dimethyl methyl phosphonate, melamine salt of dimethyl hydrogen phosphite, ammonium salt of boron-polyphosphate, urea salt of dimethyl methyl phosphonate, organophosphates, phosphonates and phosphine oxide. Phosphate esters include, for example, trialkyl derivatives, such as triethyl phosphate, tris(2-ethylhexyl)phosphate, trioctyl phosphate, triaryl derivatives, such as triphenyl phosphate, cresyl diphenyl phosphate and tricresyl phosphate and aryl-alkyl derivatives, such as 2-ethylhexyl-diphenyl phosphate and dimethyl-aryl phosphates and octylphenyl phosphate.

Other examples of phosphorous-based fire retardants include methylamine boron-phosphate, cyanuramide phosphate, magnesium phosphate, ethanolamine dimethyl phosphate, cyclic phosphonate ester, trialkyl phosphonates, potassium ammonium phosphate, cyanuramide phosphate, aniline phosphate, trimethylphosphoramide, tris(1-aziridinyl)phosphine oxide, bis(5,5-dimethyl-2-thiono-1,3,2-dioxaphosphorinamyl)oxide, dimethylphosphono-N-hydroxymethyl-3-propionamide, tris(2-butoxyethyl)phosphate, tetrakis(hydroxymethyl)phosphonium salts, such as tetrakis(hydroxymethyl)phosphonium chloride and tetrakis(hydroxymethyl)phosphonium sulfate, n-hydroxymethyl-3-(dimethylphosphono)-propionamide, a melamine salt of boron-polyphosphate, an ammonium salt of boron-polyphosphate, triphenyl phosphite, ammonium dimethyl phosphate, melamine orthophosphate, ammonium urea phosphate, ammonium melamine phosphate, a melamine salt of dimethyl methyl phosphonate, a melamine salt of dimethyl hydrogen phosphite and the like.

Metal hydroxide fire retardants include inorganic hydroxides, such as aluminum hydroxide, magnesium hydroxide, aluminum trihydroxide (ATH) and hydroxycarbonate.

Melamine-based fire retardants are a family of non-halogenated flame retardants that include three chemical groups: (a) melamine(2,4,6-triamino-1,3,5 triazine); (b) melamine derivatives (including salts with organic or inorganic acids, such as boric acid, cyanuric acid, phosphoric acid or pyro/poly-phosphoric acid); and (c) melamine homologues. Melamine derivatives include, for example, melamine cyanurate (a salt of melamine and cyanuric acid), melamine-mono-phosphate (a salt of melamine and phosphoric acid), melamine pyrophosphate and melamine polyphosphate. Melamine homologues include melam(1,3,5-triazin-2,4,6-triamine-n-(4,6-diamino-1,3,5-triazine—2-yl), melem(2,5,8-triamino 1,3,4,6,7,9,9b-heptaazaphenalene) and melon(poly[8-amino-1,3,4,6,7,9,9b-heptaazaphenalene-2,5-diyl).

Borate fire retardant compounds include zinc borate, borax (sodium borate), ammonium borate, and calcium borate. Zinc borate is a boron-based fire retardant having the chemical composition xZnO_{y}B₂O₃.zH₂O. Zinc borate can be used alone, or in conjunction with other chemical compounds, such as antimony oxide, alumina trihydrate, magnesium hydroxide or red phosphorous. It acts through zinc halide or zinc oxyhalide, which accelerate the decomposition of halogen sources and promote char formation.

Silicon-based materials include linear and branched chain-type silicone with (hydroxy or methoxy) or without (saturated hydrocarbons) functional reactive groups.

Examples of powdered metal-containing flame retardant substances, which can be employed alone or in combination with other flame retardant substances, include, but are not limited to, magnesium oxide, magnesium chloride, talcum, alumina hydrate, zinc oxide, zinc borate, alumina trihydrate, alumina magnesium, calcium silicate, sodium silicate, zeolite, magnesium hydroxide, sodium carbonate, calcium carbonate, ammonium molybdate, iron oxide, copper oxide, zinc phosphate, zinc chloride, clay, sodium dihydrogen phosphate, tin, molybdenum and zinc.

Polytetrafluoroethylene (PTFE) is also contemplated as an additional flame retardant.

Antimony oxide is a suitable additional flame retardant.

The other flame retardants and flame retardant synergists may be included in their usual amounts, such as antimony oxide up to 20% by weight, metal hydrates up to 70% by weight and fluoropolymer anti-dripping agents up to 1% by weight, all based on the weight of the polyethylene substrate in the final polyethylene article.

### EXAMPLES

### Example 1

### High Temperature Processing

Linear low density polyethylene (LLDPE) is dry mixed with the additives outlined below. Amounts are parts by weight. The mixtures are introduced into a laboratory twin-screw extruder heated to 280° C. The extruder has a screw diameter of 18 mm and a screw length to diameter ratio of 25. Screw rotation is set at 20 rpm and the output rate is about 10 lbs./hr. The extrudate is collected and examined for color, surface texture and odor. The observations are outlined below.

All formulations contain 91.6 parts by weight LDPE and 1.9 parts by weight antimony oxide. Each formulation contains as a brominated flame retardant 5.5 parts by weight tris[3-bromo-2,2-bis(bromomethyl)propyl]phosphate. Each of the formulations further contains 1.0 part by weight of a certain hindered amine light stabilizer.

Formulation 1 is of the present invention. Formulations 2-5 are comparative.

The extrudate of formulation 1 is white in color, has a smooth surface texture and has very little odor.

The extrudates of formulations 2-5 are all dark brown in color, all have a rough surface texture and all have a noticeable odor.

Formulation 1 contains 1 part of the cyclic condensate of N,N′-bis(2,2,6,6-tetramethyl-4-piperidyl)-hexamethylenediamine and 4-tert-octylamino-2,6-dichloro-1,3,5-triazine:

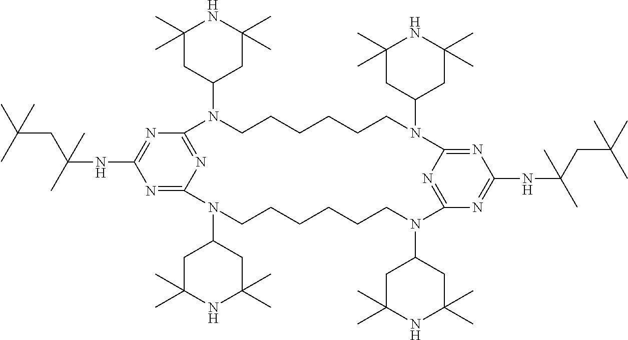

Formulation 2 contains 1 part of an oligomeric compound which is the linear condensate of N,N′-bis(2,2,6,6-tetramethyl-4-piperidyl)-hexamethylenediamine and 4-tert-octylamino-2,6-dichloro-1,3,5-triazine, MW 1200-3100:

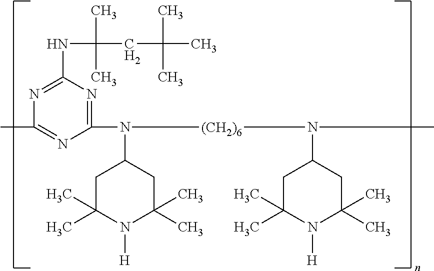

Formulation 3 contains 1 part of an oligomeric compound which is the condensate of 1-(2-hydroxyethyl)-2,2,6,6-tetramethyl-4-hydroxypiperidine and succinic acid, MW 3100-4000:

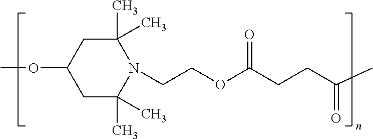

Formulation 4 contains 1 part of a mixture of hindered amines including 1-(2-hydroxy-2-methylpropoxy)-4-octadecanoyloxy-2,2,6,6-tetramethylpiperidine.
Formulation 5 contains 1 part of an oligomeric compound which is the condensation product of 4,4′-hexamethylenebis(amino-1-propoxy-2,2,6,6-tetramethylpiperidine) and 2,4-dichloro-6-[(1-propoxy-2,2,6,6-tetramethylpiperidin-4-yl)butylamino]-s-triazine end-capped with 2-chloro-4,6-bis(dibutylamino)-s-triazine, MW 2600-3400:

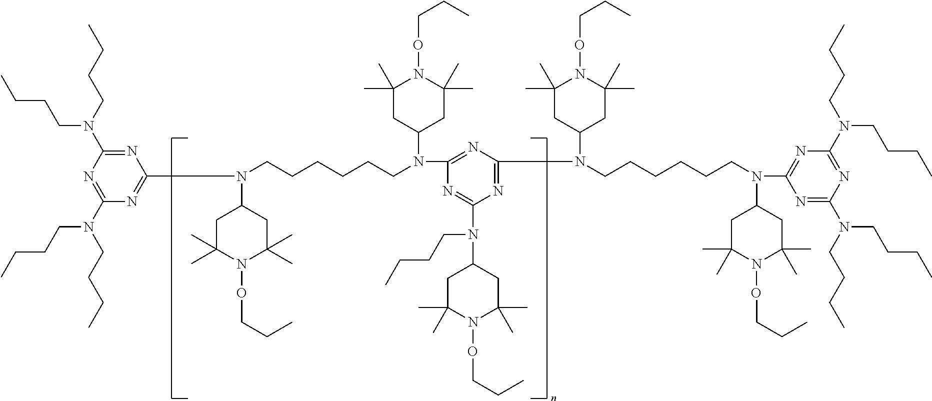

### Example 2

### High Temperature Processing

Example 1 is repeated, replacing the brominated flame retardant of each formulation with 5.5 parts by weight of tetrabromobisphenol A, bis(2,3-dibromopropyl ether).

The extrudate of the inventive formulation has a white color, a smooth surface texture and little odor.

The extrudates of the four comparative formulations each are dark brown in color, each have a rough surface texture and each have a noticeable odor.

### Example 3

### Preparation of Polyethylene Hollow Articles by the Rotomolding Process

100 parts medium density polyethylene, copolymerized with hexene (nominal melt index 3.5 g/10 min., density 0.935 g/cm³) are dry blended with 0.050 parts of zinc stearate and a combination of further additives. The mixtures are melt compounded into pellets at 232° C. in a Superior/MPM extruder using a 24:1 L/D screw with Maddock mixing head at 100 rpm. The formulations further contain 1 part of the present cyclic condensate of N,N′-bis(2,2,6,6-tetramethyl-4-piperidyl)-hexamethylenediamine and 4-tert-octylamino-2,6-dichloro-1,3,5-triazine and 5 parts of a brominated flame retardant selected from tris[3-bromo-2,2-bis(bromomethyl)propyl]phosphate and tetrabromobisphenol A, bis(2,3-dibromopropyl ether).

The compounded pellets are ground to a uniform particle size (150-500 μm) prior to the rotational molding process. This grinding step increases the surface area of the particles leading to a faster heat absorption, and thus reducing overall energy consumption.

The rotational molding process is performed in a laboratory scale equipment FSP M20 “Clamshell”. The ground resin is placed in a cast aluminum mold, which is rotated biaxially in a gas fired oven. Hot air is circulated by blowers in the chamber while the temperature is increased to 288° C. within 4 minutes. This temperature is maintained for a specific time. Subsequently, the oven is opened and while still rotating, the mold is cooled with forced air circulation for 7 minutes, followed by water spray mist for 7 minutes, and an additional air cooling step for 2 minutes. Throughout the entire heating and cooling cycles, the speed of the major axis is maintained at 6 rpm with a 4.5:1 ratio of rotation. After the cooling cycles, the mold is opened and the hollow object removed.

1. A process for the preparation of a stabilized and flame retardant polyethylene article, which process comprises
adding an effective stabilizing amount of one or more macrocyclic hindered amine light stabilizers and an effective flame retarding amount of one or more brominated flame retardants to a polyethylene substrate and
subjecting the resultant polyethylene mixture to a temperature of 250° C. or above,
where the hindered amine light stabilizers are of formula I 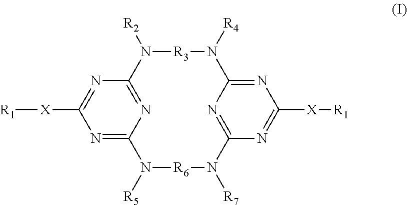
where
R₁ is hydrogen, C₁-C₁₈alkyl, C₃-C₁₈alkenyl, C₅-C₁₈cycloalkyl, C₆-C₁₈aryl, C₇-C₉aralkyl or —R₈—Y,
or R₁ is a group of formula II or III, 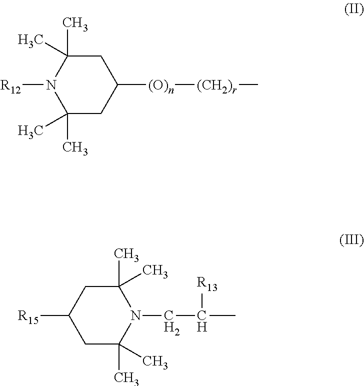
n is 0 or 1,
r is 0, 1, 2 or 3,
X is —O—, —S—, or —NR₁₆—,
XR₁ as a whole may also be chlorine or morpholino, pyrrolidin-1-yl, piperidin-1-yl or hexahydroazepin-1-yl,
R₂, R₄, R₅ and R₇ independently are hydrogen, C₁-C₁₂alkyl, C₂-C₆hydroxyalkyl, C₃-C₁₂alkenyl, C₅-C₁₂cycloalkyl, C₆-C₁₈aryl, C₇-C₉aralkyl or a group of formula II,
R₃ and R₆ independently are C₂-C₁₂alkylene, C₄-C₁₂iminodialkylene or oxadialkylene, C₅-C₁₂cycloalkylene, C₆-C₁₂arylene or C₇-C₁₂aralkylene,
R₈ is C₂-C₆alkylene,
Y is —O—R₉ or —NR₁₀R₁₁,
R₉ is hydrogen or C₁-C₁₈alkyl,
R₁₀ and R₁₁ are independently C₁-C₆alkyl, 2,2,6,6-tetramethylpiperid-4-yl or 1,2,2,6,6-pentamethylpiperid-4-yl,
R₁₂ is hydrogen, C₁-C₁₂alkyl, C₃-C₁₂alkenyl or C₇-C₉aralkyl,
R₁₃ is hydrogen, methyl, ethyl or phenyl,
R₁₄ is hydrogen, C₁-C₁₂alkyl, C₃-C₁₂alkenyl, C₇-C₉aralkyl or C₁-C₁₂acyl,
R₁₅ is hydrogen, C₁-C₈alkoxy, C₃-C₈alkenyloxy or benzyloxy and
R₁₆ is defined as for R₁ and
where at least one of the groups R₁, R₂, R₄, R₅ and R₇ is a group of formula II.

2. A process according to claim 1 comprising subjecting the polyethylene mixture to a temperature of 280° C. or above.

3. A process according to claim 1 where R₁₂ is hydrogen or methyl.

4. A process according to claim 1 where R₁X is t-octylamino or morpholino.

5. A process according to claim 1 where the hindered amine light stabilizer is

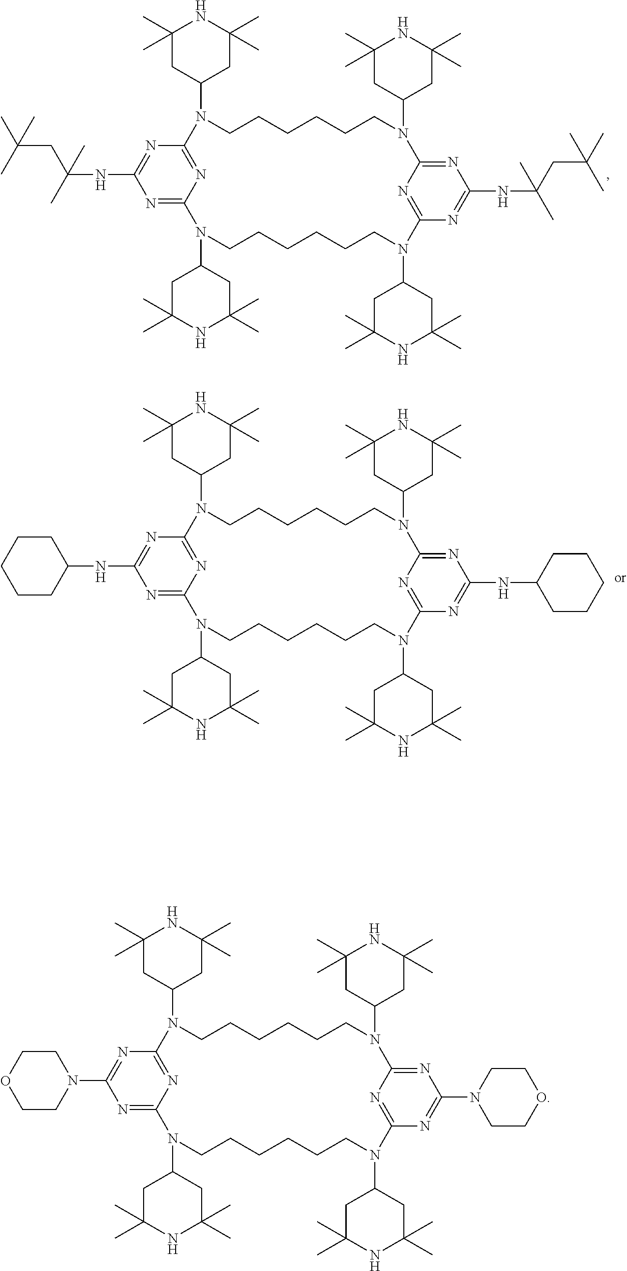

6. A process according to claim 1 where the hindered amine light stabilizer is

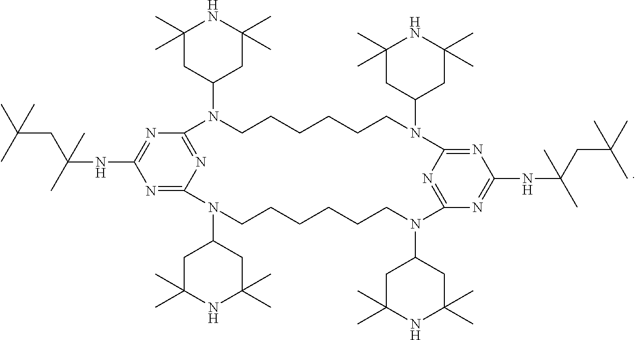

7. A process according to claim 1 which comprises a rotomolding, a film extrusion or a laminate film extrusion step.

8. A process according to claim 1 where the brominated flame retardants are selected from the group consisting of polybrominated diphenyl oxide, decabromodiphenyl oxide, tris[3-bromo-2,2-bis(bromomethyl)propyl]phosphate, tris(2,3-dibromopropyl)phosphate, tetrabromophthalic acid, bis-(N,N′-hydroxyethyl)tetrachlorphenylene diamine, tetrabromobisphenol A bis(2,3-dibromopropyl ether), brominated epoxy resin, ethylene-bis(tetrabromophthalimide), octabromodiphenyl ether, 1,2-bis(tribromophenoxy)ethane, tetrabromo-bisphenol A, ethylene bis-(dibromo-norbornanedicarboximide) and tris-(2,3-dibromopropyle)-isocyanurate.

9. A process according to claim 1 where the brominated flame retardant is tris[3-bromo-2,2-bis(bromomethyl)propyl]phosphate or tetrabromobisphenol A, bis(2,3-dibromopropyl ether).

10. A process according to claim 1 where the hindered amine light stabilizers are added in an amount of from about 0.01% to about 10% by weight and the brominated flame retardants are added in an amount of from about 0.01% to about 30% by weight, based on the weight of the polyethylene substrate.

11. An additive composition comprising one or more macrocyclic hindered amine light stabilizers and one or more brominated flame retardants, where the hindered amine light stabilizers are or formula I 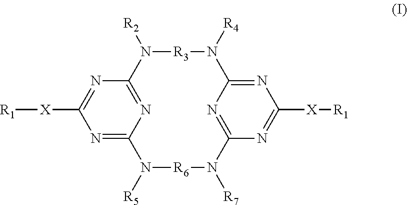
where
R₁ is hydrogen, C₁-C₁₈alkyl, C₃-C₁₈alkenyl, C₅-C₁₈cycloalkyl, C₈-C₁₈aryl, C₇-C₉aralkyl or —R₈—Y,
or R₁ is a group of formula II or III, 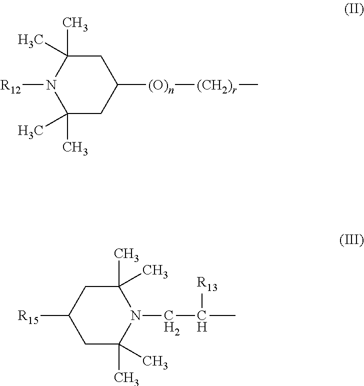
n is 0 or 1,
r is 0, 1, 2 or 3,
X is —O—, —S—, or —NR₁₆—,
XR₁ as a whole may also be chlorine or morpholino, pyrrolidin-1-yl, piperidin-1-yl or hexahydroazepin-1-yl,
R₂, R₄, R₅ and R₇ independently are hydrogen, C₁-C₁₂alkyl, C₂-C₆hydroxyalkyl, C₃-C₁₂alkenyl, C₅-C₁₂cycloalkyl, C₆-C₁₈aryl, C₇-C₉aralkyl or a group of formula II,
R₃ and R₆ independently are C₂-C₁₂alkylene, C₄-C₁₂iminodialkylene or oxadialkylene, C₅-C₁₂cycloalkylene, C₆-C₁₂arylene or C₇-C₁₂aralkylene,
R₈ is C₂-C₆alkylene,
Y is —O—R₉ or —NR₁₀R₁₁,
R₉ is hydrogen or C₁-C₁₈alkyl,
R₁₀ and R₁₁ are independently C₁-C₆alkyl, 2,2,6,6-tetramethylpiperid-4-yl or 1,2,2,6,6-pentamethylpiperid-4-yl,
R₁₂ is hydrogen, C₁-C₁₂alkyl, C₃-C₁₂alkenyl or C₇-C₉aralkyl,
R₁₃ is hydrogen, methyl, ethyl or phenyl,
R₁₄ is hydrogen, C₁-C₁₂alkyl, C₃-C₁₂alkenyl, C₇-C₉aralkyl or C₁-C₁₂acyl,
R₁₅ is hydrogen, C₁-C₈alkoxy, C₃-C₈alkenyloxy or benzyloxy and
R₁₆ is defined as for R₁ and
where at least one of the groups R₁, R₂, R₄, R₅ and R₇ is a group of formula II.

12. An additive composition according to claim 11 where R₁₂ is hydrogen or methyl.

13. An additive composition according to claim 11 where R₁X is t-octylamino or morpholino.

14. An additive composition according to claim 11 where the hindered amine light stabilizer is

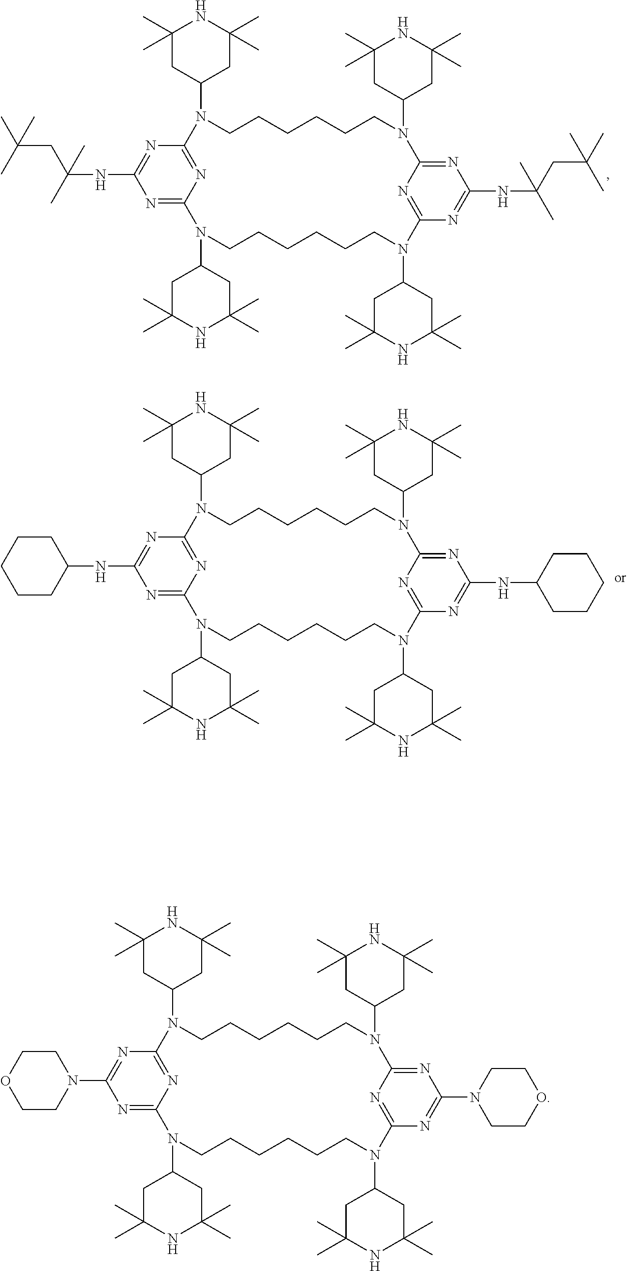

15. An additive composition according to claim 11 where the hindered amine light stabilizer is

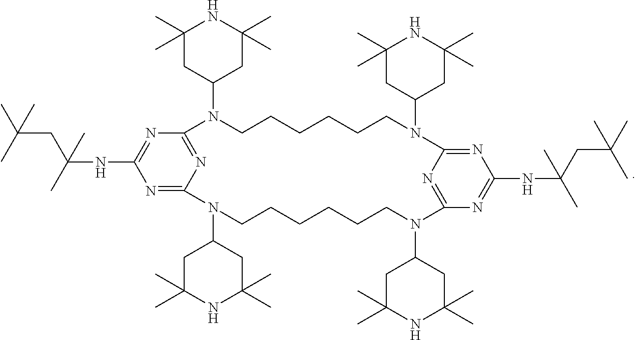

16. An additive composition according to claim 11 where the brominated flame retardants are selected from the group consisting of polybrominated diphenyl oxide, decabromodiphenyl oxide, tris[3-bromo-2,2-bis(bromomethyl)propyl]phosphate, tris(2,3-dibromopropyl)phosphate, tetrabromophthalic acid, bis-(N,N′-hydroxyethyl)tetrachlorphenylene diamine, tetrabromobisphenol A bis(2,3-dibromopropyl ether), brominated epoxy resin, ethylene-bis(tetrabromophthalimide), octabromodiphenyl ether, 1,2-bis(tribromophenoxy)ethane, tetrabromo-bisphenol A, ethylene bis-(dibromo-norbornanedicarboximide) and tris-(2,3-dibromopropyle)-isocyanurate.

17. An additive composition according to claim 11 where the brominated flame retardant is tris[3-bromo-2,2-bis(bromomethyl)propyl]phosphate or tetrabromobisphenol A, bis(2,3-dibromopropyl ether).

18. An additive composition according to claim 11 where the weight:weight ratio of hindered amines to brominated flame retardants ranges from 1:99 to 99:1.
